(19) United States
(12) Patent Application Publication
(10) Pub. No.: US 2016/0101506 A1
(43) Pub. Date: Apr. 14, 2016

(54) Securing System for Power Wrenches and a Power Wrench

(71) Applicant: WAGNER VERMÖGENSVERWALTUNGS-GMBH & CO. KG, Much (DE)

(72) Inventors: Andreas Niemietz, Much (DE); Igor Cherepinski, Bergisch Gladbach (DE)

(21) Appl. No.: 14/895,289

(22) PCT Filed: Jun. 2, 2014
(86) PCT No.: PCT/EP2014/061400

§ 371 Date: Dec. 2, 2015

(30) Foreign Application Priority Data
Jun. 3, 2013 (DE) 10 2013 210 268.2

(51) Int. Cl. B25B 21/00; B25B 23/08

(52) U.S. Cl. CPC B25B 21/00; B25B 23/08

(57) ABSTRACT

A securing system for power wrenches, for immobilizing a power wrench, which is placed on a threaded bolt with a nut, in an axial direction of the threaded bolt is provided. The securing system includes a securing device. The securing device includes a locking element which engages with a threaded section of the threaded bolt projecting over the nut, the locking element being movable in a radial direction relative to the threaded bolt to engage with the threaded section of the threaded bolt.

The present invention relates to a securing system for power wrenches, and to a power wrench provided with such a securing system.

Power wrenches, which can be driven hydraulically, pneumatically or electrically, are used for tightening and releasing nuts on screw bolts or threaded bolts. In known power wrenches, an output element of the power wrench is often rotated in intervals. After each rotating interval, the output device has a tendency to rotate backward by a small angular amount because the screw construction and/or the power wrench will become partially slackened. During such a rotating interval or during said slackening subsequent to the rotating interval, movements of the power wrench may occur so that the latter may happen to get detached from the nut of the screw construction.

In practical use, for this reason, power wrenches will mostly be held by hand. Generally, however, there is the disadvantage of a safety risk caused by non-existing or unreliable holding systems. Also when the drive of the power wrench is stopped, or in case of an undesired interruption e.g. due to power fallout, the power wrenches may become detached from the to-be-rotated screw in the working process. On the whole, thus, there is a non-negligible danger of accidents.

Since conventional power wrenches are often held by hand for avoidance of an accident risk, a single user can operate only one power wrench at a time. A reliable holding system for power wrenches would have the advantage of allowing a plurality of power wrenches to be operated simultaneously by one user.

Thus, it is an object of the present invention to provide a securing system for power wrenches which is easily operated and will reliably prevent a detachment of the power wrench from the screw to be rotated.

The securing system according to the invention is defined by claim 1. In the inventive securing system for power wrenches, by which a power wrench applied on a threaded bolt with nut can be immobilized in the axial direction of the threaded nut bolt which comprises a securing device for holding the power wrench, it is provided that said securing device comprises a locking device engaging into the thread of a section of the threaded bolt projecting over the nut, the locking device being movable in the radial direction relative to the threaded bolt so as to engage into the thread of the threaded bolt.

By said engagement of the securing device into the thread of a section of the threaded bolt projecting over the nut, a power wrench can be secured in radial direction in a particularly simple manner since, by means of the securing device, an axial movement of the power wrench can be blocked directly. By the provision of a locking device which is movable in the radial direction relative to the threaded bolt, the securing device can be placed at a random site of the thread of the threaded bolt and engage into the thread, without the need to screw the securing device onto the thread by way of a complex process, e.g. by rotational movement. For instance, the securing device can simply be mounted onto the threaded bolt, and the locking device will then be inserted into at least one thread turn of the thread. Beyond this, the securing system has the advantage of allowing for an engagement occurring directly with that component against which a relative movement of the power wrench shall be reduced or prevented.

Thus, securement of the power wrench against detachment from the screw can be achieved in a reliable manner, thereby distinctly reducing the safety risk during the tightening of screws.

Power wrenches are often used for releasing old screws. In such situations, it may be the case that the thread of the section of the threaded bolt projecting beyond the nut has been damaged or soiled or has been altered by a layer of lacquer. By the provision of the locking device which will be shifted onto the thread in radial direction, the securing system of the invention can be fastened on the thread without the possibility that the condition of the thread will prevent this shift-on movement. An approach involving a screw-on attachment, on the other hand, could result in problems due to the condition of the thread.

In the context of the present invention, threaded bolts are understood to comprise threaded bolts to be secured on both sides by nuts, as well as threaded bolts in the form of screw bolts comprising a screw head on one end. Also threaded bolts of the type which are fastened to constructional components and onto which a nut will be placed from one side, are understood to be threaded bolts in the context of the invention.

Preferably, it is provided that the locking device consists of at least one sliding element. Of course, also a plural number of sliding elements can be provided. By use of a sliding element, the locking device can be realized in a simple manner under the constructional aspect, while a sliding element is also conveniently shiftable in a radial direction relative to the threaded bolt. Preferably, the sliding element is adapted to the thread of the threaded bolt. For instance, the sliding element can engage into one or a plurality of thread turns of the thread of the threaded bolt. Preferably, the sliding element is adapted to the pitch of the thread.

According to a preferred embodiment, it is provided that the sliding element is plate-shaped. Due to the plate-shaped design of the sliding element, the sliding element can be guided within the securing device in an advantageous manner, e.g. by sliding in a guide track.

The securing device can comprise a spring device adapted to move—preferably by pressing—the sliding element into the engagement position. Thereby, detachment of the securing device will be prevented in an advantageous manner because, under the effect of the spring device, the sliding element will always be forced into the direction of the engagement position.

Preferably, it is provided that the sliding element is formed with a recess, wherein, when in the engagement position, the sliding element engages into the thread by an edge delimiting said recess. By way of the recess, the securing system of the invention can be secured on the threaded bolt in a particularly advantageous manner in that, when placing the securing system on the threaded bolt, the threaded bolt will be guided through the recess of the sliding element. Subsequently, by way of a radial shifting movement, the sliding element can be shifted in a particularly simple manner into the engagement position in which an edge delimiting the recess is in engagement with the thread. The edge delimiting the recess can be designed to engage into one or a plurality of thread turns of the thread. The recess can have a closed shape so that the recess forms a through hole, or it can have an open shape so that the sliding element is substantially fork-shaped with a U-shaped recess. In case of the closed design, the recess can be shaped substantially as a longitudinal hole.

Said U-shaped design of the recess or said recess design as a longitudinal hole has the advantage that the recess can have an area with a diameter which is larger than the outer diameter of the thread of the threaded bolt so that, when placing the securing system onto the threaded bolt, the securing system can be shifted over the threaded bolt without difficulties. A second area of the recess can have a diameter which is smaller than the outer diameter of the thread of the threaded bolt but larger than the core diameter of the latter, so that, in the engagement position, said recess-delimiting edge arranged in this area can engage into the thread.

It can be provided that the edge is adapted to the pitch of the thread. In this case, the edge can be arranged e.g. at an angle adapted to the pitch angle of the thread of the threaded bolt, so that, in the engagement position of the sliding element, the edge will have been shifted into a thread turn of the thread and will extend parallel to said thread turn. Of course, it is also possible that the edge comprises a plurality of engagement areas for engagement into the thread. For instance, there can be provided two ribs projecting from the edge of the recess, the ribs being adapted to the pitch angle.

According to a particularly preferred embodiment of the invention, an adapter piece is provided which is connected to the securing device for common rotation therewith and is connectible to the output side of the power wrench in a form-locking manner. Preferably, said form-locking connection is established by the hexagonal connecter of the power wrench. By said adapter piece connected to the securing device for common rotation therewith, it can be achieved that, with each rotational movement of the power wrench, the securing device will be co-rotated and will thus move on the threaded bolt in the axial direction of the threaded bolt to the same extent as the nut. Thereby, when tightening the nut, it is e.g. prevented that a gap is generated in axial direction between the securing system and the power wrench, which might cause movements of the power wrench in the axial direction of the threaded bolt. When nuts are being released, the co-rotation of the securing device will prevent the possibility of a jamming of the releasing nut and the securing device.

The securing system can be provided as a separate unit which, for use as a safety device, will be mounted onto the power wrench. Of course, it is also possible to integrate the safety device into parts of the power wrench that are necessary for the screwing process. For instance, it can be provided that the securing device is arranged in a plug-on socket or in a hexagonal socket of the power wrench. This way, the securing device can be combined with a power wrench in a particularly simple manner, wherein it is further accomplished that, during operation of the wrench, the securing device will be co-rotated.

In those exemplary embodiments of the invention in which, during operation of the wrench, the securing device is co-rotated, said spring device which presses the sliding element into the engagement position further has the advantage that a possible unevenness and damage of the thread can be compensated for. In case that, during the rotary movement, the portion of the sliding element engaging into the thread will e.g. hit upon an unevenness in the thread, the sliding element can be at least partially pressed out of the engagement position against the force of the spring device while, subsequently, after the unevenness has been overcome, it will again be pressed entirely into the engagement position by the spring device.

The invention further relates to a power wrench provided with a securing system according to the invention.

The invention will be explained in greater detail hereunder with reference to the Figures mentioned hereunder.

In the Figures, the following is shown:

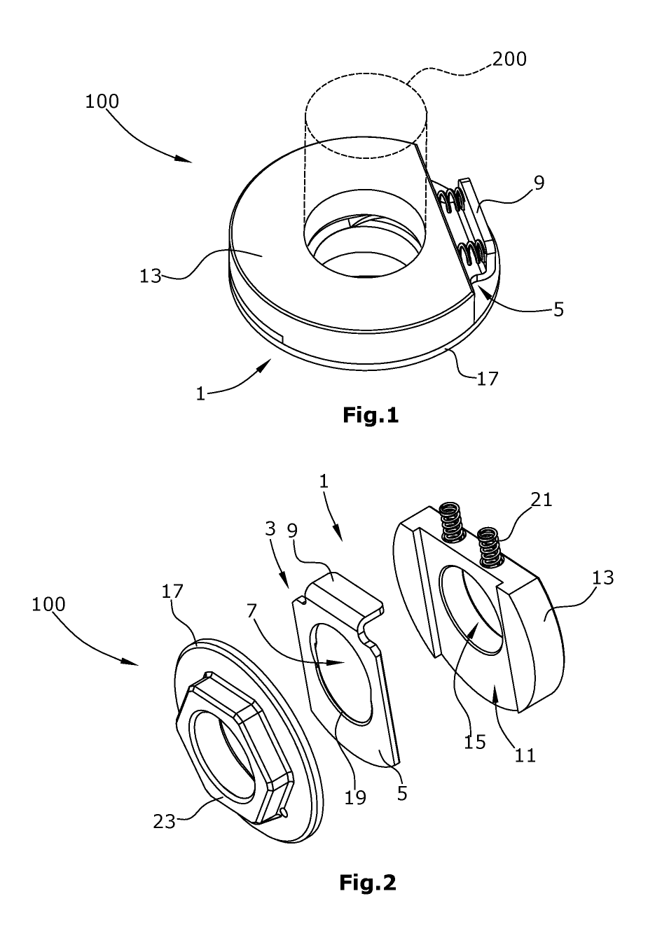

FIG. 1 is a schematic perspective view of a securing device of a securing system according to the invention,

FIG. 2 is a schematic exploded view of the securing device shown in FIG. 1,

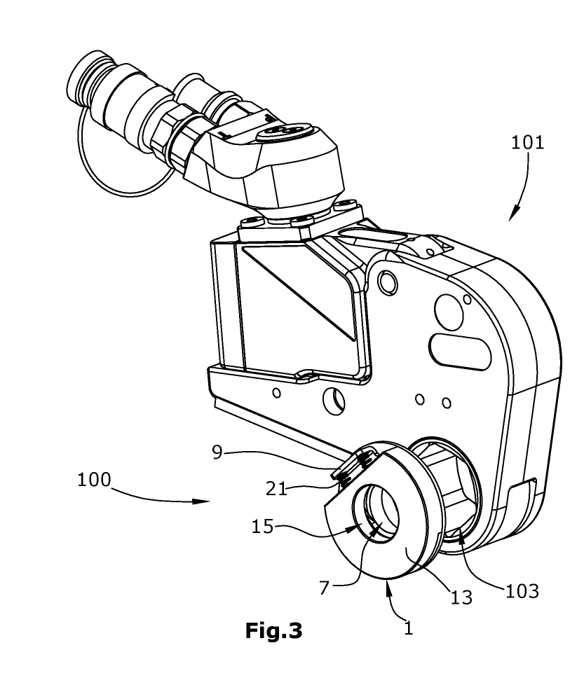

FIG. 3 is a view of the securing system in connection with a hydraulic power wrench,

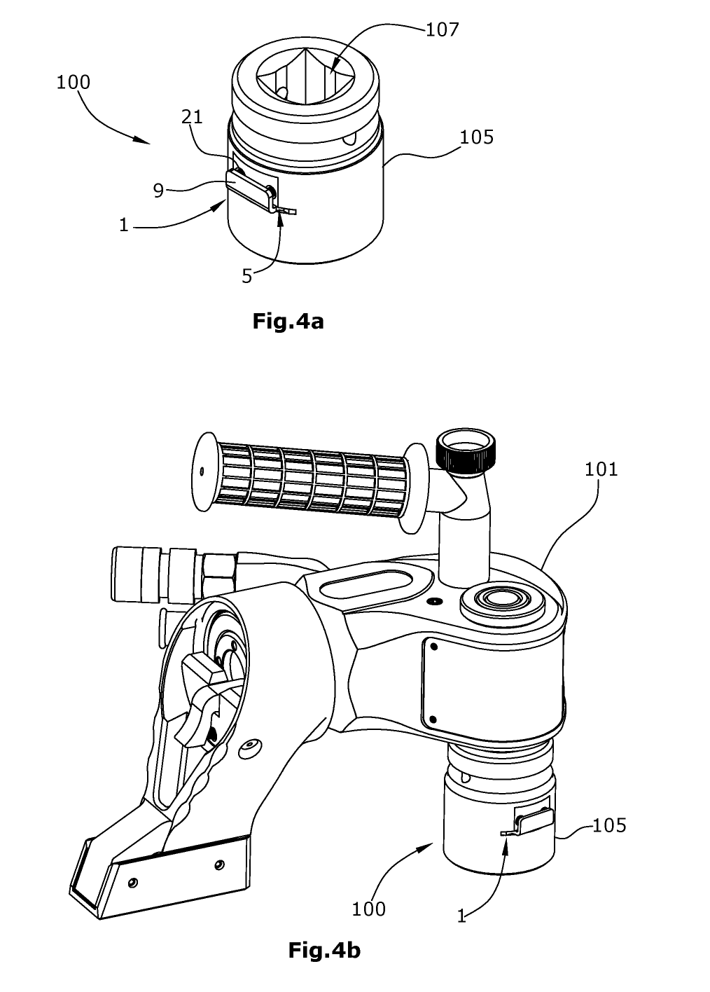

FIGS. 4a and 4b are views of a second exemplary embodiment of a securing system according to the invention in a variant integrated into a plug-on nut, and in connection with a power wrench,

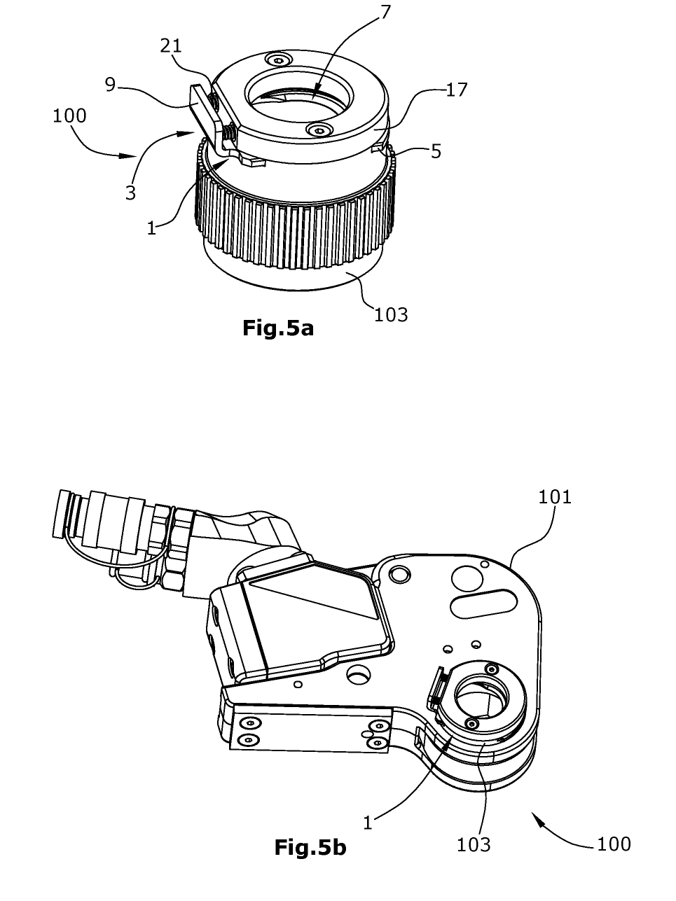

FIGS. 5a and 5b are views of a securing system according to the invention in a variant integrated into a hexagonal socket, and in connection with a power wrench.

FIGS. 1-3 schematically show a first embodiment of a securing system 100 according to the invention for use in a power wrench 101. The securing system 100 serves for immobilizing a power wrench 101 placed onto a threaded bolt 200 with nut, notably in the axial direction of the threaded bolt 200. The threaded bolt 200 is merely schematically outlined in FIG. 1.

The securing system 100 includes a securing device 1 comprising a locking device 3. The locking device 3 consists of a sliding element 5 which in the illustrated exemplary embodiment is of a plate-shaped configuration and comprises a recess 7 in the form of a through hole. The locking device 3 further comprises an actuating element 9 which in the illustrated exemplary embodiment is formed by a folded edge of the plate which the sliding element 5 is made of. The sliding element 5 is guided in a guide track 11 of a housing 13. The housing 13 comprises a through bore 15 which is adapted to the recess 7. With the aid of a cover 17, the sliding element 5 is held in the guide track 11 of housing 13.

By use of the actuating element 9, the locking device 3 can be operated so that the sliding element 5 can be shifted in radial direction relative to the threaded bolt 200. In the engagement position of sliding element 5, an edge 19 delimiting the recess 7 engages into a thread turn of threaded bolt 200. For this purpose, said edge 19 is designed in such a manner that it is adapted to the pitch of the thread of threaded bolt 200 and presents an angle relative to the plane formed by sliding element 5, which angle is adapted to the pitch angle of the thread.

On housing 13, there is arranged a spring device 21 which is effective between housing 13 and actuating element 9. By means of said spring device 21, the sliding element 5 is pressed into the engagement position. In other words: When the securing system 100 is placed onto the threaded bolt 200, the securing device 1 will be actuated by shifting the locking device 3 against the spring force 21, so that the sliding element 5 will be in the non-engagement position. In this position, said through bore 15 in housing 13 and the recess 7 in sliding element 5 will form a passage whose diameter is larger than the outer diameter of threaded bolt 200. Thus, the securing device 1 can be shifted onto the threaded bolt 200 in a simple manner. By releasing the actuating element 9, the sliding element 5 is pressed under the action of spring device 21 into the engagement position so that the edge 19 is caused to engage into the thread of threaded bolt 200. By engagement into the thread of threaded bolt 200, the securing system 100 has now been immobilized in the axial direction of threaded bolt 200 and can axially secure a power wrench 101 applied onto threaded bolt 200.

The securing system 100 further comprises an adapter piece 23 which is connected to the securing device 1 for common rotation therewith and is connectible to the output side of the power wrench 101 in a form-locking manner. In the exemplary embodiment of the securing system 100 shown in FIGS. 1-3, said adapter piece 23 has a hexagonal shape, thus allowing the securing system 100 to be connected to a hexagonal connecter 103 of the power wrench 101 in a form-locking manner. Said form-locking connection makes it possible that, when the power wrench 101 is rotated, the securing system 100 and thus the securing device 1 will be rotated along with it. Thereby, it is prevented that the process of tightening a nut with the aid of the power wrench 101 will cause an axial distance to be generated between the power wrench 101 and the securing system 100; instead, during rotational movement in the axial direction along the thread of threaded bolt 200, the securing system 100 will be moved in the same manner as the nut. Since the edge 19 engages merely into a partial area of the thread of threaded bolt 200, also jamming is prevented.

As best evident in FIG. 3, said housing 13 and said cover 17 are designed in a manner forming an abutment surface onto the power wrench 101 so that the power wrench 101 is secured in an advantageous manner in the axial direction of threaded bolt 200.

Said spring device 21 has the further advantage that possible damage or contamination occurring in the thread turns of the thread of threaded bolt 200 can be compensated during the co-rotation of securing device 1 in that, for a short time, the sliding element 5 will be pressed at least partially out of the engagement position against the spring force of spring device 21.

In FIGS. 4a and 4b, there is shown a second exemplary embodiment of a securing system 100 according to the invention. In the exemplary embodiment shown in FIGS. 4a and 4b, the securing system 100 consists of a plug-on socket 105. The sliding element 5 of locking device 3 is—in this exemplary embodiment—guided through a slot in the outer surface into the interior of said plug-on socket 105. The spring device 21 is effective between said outer surface and the actuating element 9. The plug-on socket 105 will be connected to the power wrench 101 via a square opening 107. The plug-on socket 105 will be fastened to a square drive element of power wrench 101 via a conventional holding system. In this arrangement, a holding pin engages into a corresponding cutout opening in the square hole of plug-on socket 105 and secures the latter in the axial direction relative to power wrench 101. In the state of the power wrench with plug-on socket 105 as applied onto threaded bolt 200, the power wrench 101 is thus secured, by the securing device 1 of the invention and the holding system, in the axial direction of threaded bolt 200.

FIGS. 5a and 5b schematically show a second exemplary embodiment of a securing system 100 according to the invention. In this exemplary embodiment, the securing device 1 of the invention is integrated into an hexagonal insert 103 of a power wrench 101. The locking device 3 is guided, by means of a sliding element 5, in a guide path formed on the upper side of said hexagonal insert. Further, by means of a cover 17, the locking device 3 is held in the guide path. As in the above described exemplary embodiments, locking device 3 comprises an actuating element 9 by which the sliding element 5 can be displaced in the axial direction of threaded bolt 200. In the exemplary embodiment shown in FIG. 5a, the likewise provided spring device 21 is effective between cover 17 and actuating element 9. By way of hexagonal insert 103, the securing device 1 of the invention can be connected in a simple manner to the output side of a power wrench 101, it being achieved at the same time that the securing device 1 will be moved along with each rotary movement of hexagonal insert 103.

The hexagonal insert 103 is held in a conventional manner in axial direction relative to power wrench 101. Thus, via this conventional holding system and the securing device 1 of the invention, the power wrench 101 when placed on the threaded bolt 200 can be secured in the axial direction of threaded bolt 200.

The securing system 100 according to the invention has the advantage that, by way of the axial securement of the power wrench 101 relative to the threaded bolt 200, undesired detachment of the power wrench 101 from the threaded bolt 200 will be prevented and the danger of accidents will be distinctly reduced. Further, it is achieved that an operating person can operate a plurality of power wrenches 101 at the same time because the power wrenches do not need to be held by hand as had been the case with conventional power wrenches. Thus, the power wrench 101 of the invention comprising the securing system 100 of the invention can be used in an especially effective and safe manner.

1. A securing system for power wrenches, for immobilizing a power wrench placed on a threaded bolt with a nut, in an axial direction of the threaded bolt,
comprising a securing device, wherein
said securing device comprises a locking device engaging into a thread of a section of the threaded bolt projecting over the nut, the locking device being movable in a radial direction relative to the threaded bolt to engage into the thread of the threaded bolt.

2. The securing system according to claim 1, wherein the locking device consists of at least one sliding element.

3. The securing system according to claim 2, wherein the sliding element is adapted to the thread of the threaded bolt.

4. The securing system according to claim 2, wherein the sliding element is plate-shaped.

5. The securing system according to claim 2, wherein the securing device comprises a spring device for moving the sliding element into an engagement position.

6. The securing system according to claim 2, wherein the sliding element is formed with a recess, and wherein, when in an engagement position, the sliding element engages into the thread by an edge delimiting said recess.

7. The securing system according to claim 6, wherein the edge is adapted to a pitch of the thread.

8. The securing system according to claim 1, wherein an adapter piece is provided which is connected to the securing device for common rotation therewith and is connectible to the output side of the power wrench in a form-locking manner.

9. The securing system according to claim 1, wherein the securing device is arranged in a plug-on socket or in a hexagonal connecter of the power wrench.

10. A power wrench comprising a securing system for immobilizing the power wrench when placed on a threaded bolt with a nut, in an axial direction of the threaded bolt,
comprising a securing device, wherein
said securing device comprises a locking device engaging into a thread of a section of the threaded bolt projecting over the nut, the locking device being movable in a radial direction relative to the threaded bolt to engage into the thread of the threaded bolt.

11. The securing system according to claim 3, wherein the sliding element is plate-shaped.
